(19) United States
(12) Patent Application Publication
(10) Pub. No.: US 2015/0070208 A1
(43) Pub. Date: Mar. 12, 2015

(54) WEATHER RADAR AND WEATHER OBSERVATION METHOD

(71) Applicant: KABUSHIKI KAISHA TOSHIBA, Minato-ku (JP)

(72) Inventors: Hideto GOTO, Yokohama-shi (JP); Fumihiko MIZUTANI, Yokohama-shi (JP); Masakazu WADA, Yokohama-shi (JP)

(73) Assignee: KABUSHIKI KAISHA TOSHIBA, Minato-ku (JP)

(21) Appl. No.: 14/323,406

(22) Filed: Jul. 3, 2014

(30) Foreign Application Priority Data
Sep. 12, 2013 (JP) 2013-189803

(51) Int. Cl. G01S 13/95

(52) U.S. Cl. CPC G01S 13/95
USPC 342/26 R

(57) ABSTRACT

According to one embodiment, weather radar includes first antenna unit, second antenna unit, transmitter and receiver. First antenna electronically scans first area of observation space with first transmission beams. Second antenna electronically scans second area whose slant range is shorter than that of first area with second transmission beams of wider width than first transmission beams. Transmitter transmits radio wave to first area from first antenna with first transmission beams and transmits radio wave to second area from second antenna with second transmission beams. Receiver forms reception beams with first antenna to receive reflected wave from first area and reflected wave from second area with reception beams.

### CROSS-REFERENCE TO RELATED APPLICATIONS

This application is based upon and claims the benefit of priority from the Japanese Patent Application No. 2013-189803, filed Sep. 12, 2013, the entire contents of which are incorporated herein by reference.

### FIELD

Embodiments described herein relate generally to a weather radar and a weather observation method capable of three-dimensionally observing a weather phenomenon (to be referred to as an observation target hereinafter) such as rain, snow, hail, cloud, fog, or thunder.

### BACKGROUND

A mechanical scanning weather radar includes a parabolic antenna capable of forming a pencil beam. A radar of this type rotates the parabolic antenna fixed at a given elevation angle by 360°, and acquires observation data of one plane scanned by the pencil beam. The radar also acquires observation data of another plane by changing the elevation angle of the parabolic antenna only a little. This process is repeated, thereby collecting three-dimensional observation data. Since the antenna elevation angle needs to be mechanically changed, it is difficult to quickly collect three-dimensional observation data by the mechanical scanning weather radar.

On the other hand, an electronic scanning weather radar mechanically rotates the antenna by 360° in the azimuth direction, and electronically scans antenna beams in the elevation direction. Hence, the electronic scanning weather radar can quickly collect three-dimensional observation data as compared to the mechanical scanning weather radar.

The observation area of the weather radar can roughly be divided into a low elevation area close to the ground and a high elevation area in a direction upward into the air. In the low elevation area, points as far as possible away are preferably observed. Hence, a high power antenna having a large aperture is necessary. To apply the antenna to a dual-polarization radar, the cross-polarization characteristic of the antenna also needs to be improved. Since these factors lead to an increase in the cost and size of the radar apparatus, a solution of some kind is demanded.

### BRIEF DESCRIPTION OF THE DRAWINGS

FIG. 1 is an outside perspective view showing an example of a weather radar according to an embodiment;

FIG. 2 is a functional block diagram showing an example of the weather radar shown in FIG. 1;

FIG. 3 is a view showing an example of weather observation by the weather radar according to the embodiment;

FIG. 4 is a view showing an example of a longitudinal section of an observation space shown in FIG. 3;

FIG. 5 is a view showing an example of weather observation by an existing weather radar for the sake of comparison; and

FIG. 6 is a view for explaining the time necessary for observation by the existing weather radar.

### DETAILED DESCRIPTION

In general, according to one embodiment, a weather radar includes a first antenna unit, a second antenna unit, a transmitter and a receiver. The first antenna unit electronically scans a first area of an observation space with first transmission beams. The second antenna unit electronically scans a second area whose slant range is shorter than that of the first area with second transmission beams of wider width than the first transmission beams. The transmitter transmits a radio wave to the first area from the first antenna unit with the first transmission beams and transmits a radio wave to the second area from the second antenna unit with the second transmission beams. The receiver forms reception beams with the first antenna unit to receive a reflected wave from the first area and a reflected wave from the second area with the reception beams.

Various embodiments will be described hereinafter with reference to the accompanying drawings.

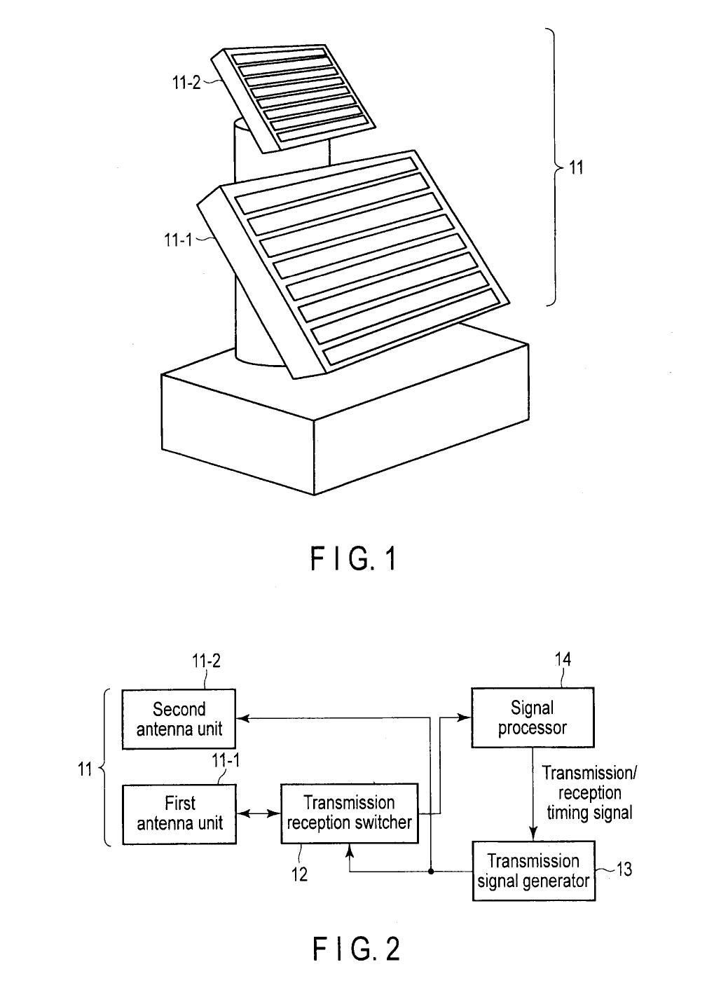

FIG. 1 is an outside perspective view showing an example of a weather radar according to an embodiment. The weather radar shown in FIG. 1 includes an antenna section 11 including a first antenna unit 11-1 and a second antenna unit 11-2. The antenna section 11 three-dimensionally electronically scans transmission beams. The weather radar observes an observation target in an observation space.

FIG. 2 is a functional block diagram showing an example of the weather radar shown in FIG. 1. The weather radar shown in FIG. 2 includes the first antenna unit 11-1, the second antenna unit 11-2, a transmission reception switcher 12, a transmission signal generator 13, and a signal processor 14.

The first antenna unit 11-1 is an electronic scanning antenna including a plurality of antenna elements arranged to form an array. The first antenna unit 11-1 forms transmission beams and radiates radio waves to a low elevation area by the formed transmission beams. That is, the first antenna unit 11-1 electronically scans the low elevation area by the transmission beams.

In this embodiment, the aperture area of the first antenna unit 11-1 is preferably made large so as to narrow the width (especially the width in the vertical direction) of the transmission beams that electronically scan the low elevation area. In the low elevation area, points as far as possible away are preferably observed. That is, the slant range is long in the low elevation area. Hence, the effective isotropically radiated power of the first antenna unit 11-1 is preferably made as high as possible, and the cross-polarization characteristic is preferably made as good as possible.

The second antenna unit 11-2 also is an electronic scanning antenna including a plurality of antenna elements arranged to form an array. The second antenna unit 11-2 forms transmission beams and radiates radio waves to a high elevation area by the formed transmission beams.

In this embodiment, the beam width of the transmission beam formed by the second antenna unit 11-2 is made wider than the beam width of the transmission beam formed by the first antenna unit 11-1. That is, the second antenna unit 11-2 can form a fan beam having a wide beam width. Hence, the aperture area of the second antenna unit 11-2 can be made smaller than that of the first antenna unit 11-1. The second antenna unit 11-2 electronically scans the high elevation area with the fan beams having a wide beam width.

Since observation targets (rain clouds) exist up to the troposphere (at an altitude of about 14 km) at most, the slant range of the high elevation area is much shorter than that of the low elevation area. For this reason, the observation range to observe the high elevation area can be much shorter than the observation range to observe the low elevation area.

Hence, the effective isotropically radiated power of the second antenna unit 11-2 can be lower than that of the first antenna unit 11-1. In the high elevation area, it is inevitably difficult to do observation by exploiting the characteristic of dual-polarization. Hence, the cross-polarization characteristic of the second antenna unit 11-2 need not be as good as that of the first antenna unit 11-1.

Hence, according to this embodiment, an antenna having a relatively small aperture area, low power, and lenient conditions of cross-polarization characteristic can be applied as the second antenna unit 11-2. That is, the second antenna unit 11-2 can be smaller and cheaper than the first antenna unit 11-1. It is therefore possible to suppress the total cost of the antenna unit and reduce the size of the overall antenna unit.

The transmission reception switcher 12 switches the transmission and reception timings based on a transmission/reception timing signal. The transmission/reception timing signal is output from the signal processor 14 and given to the transmission reception switcher 12 via the transmission signal generator 13.

The transmission signal generator 13 generates a transmission signal to be output to the first antenna unit 11-1 and the second antenna unit 11-2 based on the transmission/reception timing signal. The parameters (transmission power, transmission frequency, transmission pulse, and the like) of the transmission signal can be set to optimum values in accordance with weather conditions, apparatus conditions, and the like. When given the transmission signal, the first antenna unit 11-1 transmits a radio wave to the low elevation area, and the second antenna unit 11-2 transmits a radio wave to the high elevation area.

The signal processor 14 outputs a transmission/reception timing signal to the transmission signal generator 13. The signal processor 14 also forms reception beams with the first antenna unit 11-1, and receives reflected waves from the observation target with the reception beams. The signal processor 14 also processes a reception signal based on the reflected waves received by the first antenna unit 11-1, and generates a target signal.

Reflected waves arrive from both the low elevation area and the high elevation area. The reflected wave that arrives from the low elevation area is based on the radio wave transmitted from the first antenna unit 11-1. The reflected wave that arrives from the high elevation area is based on the radio wave transmitted from the second antenna unit 11-2. In the embodiment, the first antenna unit 11-1 receives both radio waves. That is, in the weather radar according to the embodiment, the first antenna unit 11-1 is commonly used to receive reflected waves in the high elevation area and the low elevation area.

The aperture area of the first antenna unit 11-1 is larger than that of the second antenna unit 11-2. Hence, the first antenna unit 11-1 can form a thinner reception beam than the second antenna unit 11-2. That is, a higher spatial resolution can be obtained using only the first antenna unit 11-1 in place of the second antenna unit 11-2. The functions of the weather radar having the above arrangement will be described next.

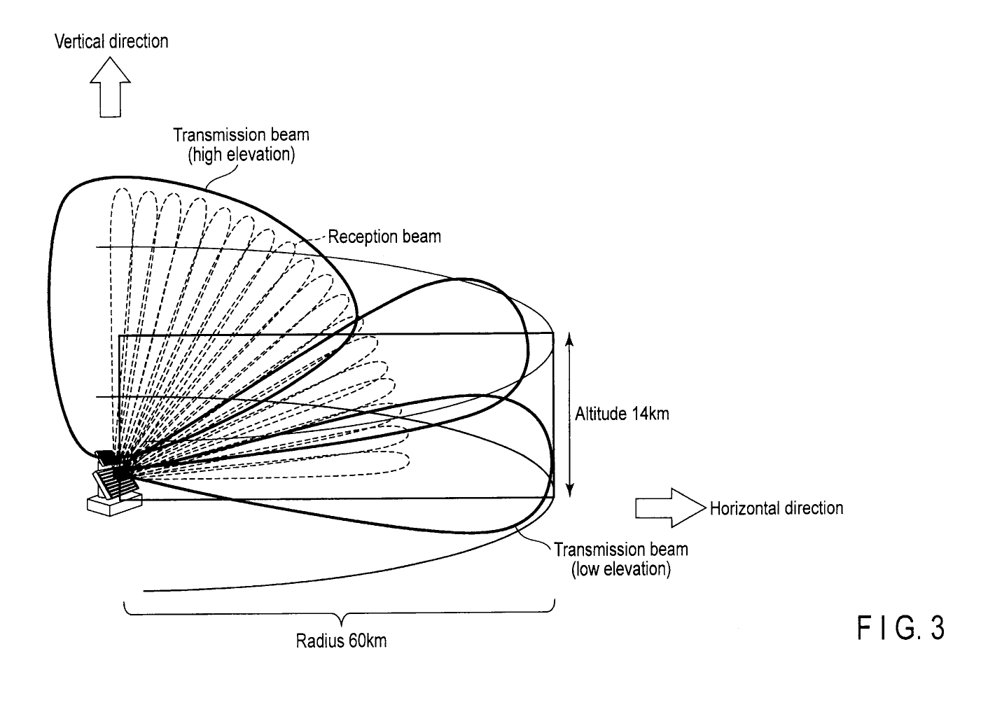

FIG. 3 is a view showing an example of weather observation by the weather radar according to the embodiment. In the embodiment, a columnar space having a height of 14 km and a radius of 60 km with respect to the weather radar as the center is assumed to be an observation space.

Referring to FIG. 3, the weather radar electronically scans the low elevation area with narrow transmission beams radiated from the first antenna unit 11-1. The weather radar also electronically scans the high elevation area with wide transmission beams radiated from the second antenna unit 11-2.

In particular, the first antenna unit 11-1 and the second antenna unit 11-2 may simultaneously form transmission beams and simultaneously scan the low elevation area and the high elevation area. Each area may be scanned at an arbitrary timing, as a matter of course. The scan timing is controlled based on the transmission/reception timing signal output from the signal processor 14.

A rectangular section is obtained by vertically cutting the columnar space shown in FIG. 3. That is, since the shape of the observation area in the elevation direction is rectangular, the observation range is changed in accordance with the elevation angle. That is, the observation range is made long at a low elevation angle and is shortened as the elevation angle becomes high, thereby minimizing the processed data amount and preventing the observation speed from lowering.

The processing unit of the elevation direction (to be referred to as an elevation processing unit; unit is ° (degrees)) is preferably set in consideration of the shape of the observation range. In the embodiment, the elevation processing unit is set for each transmission beam.

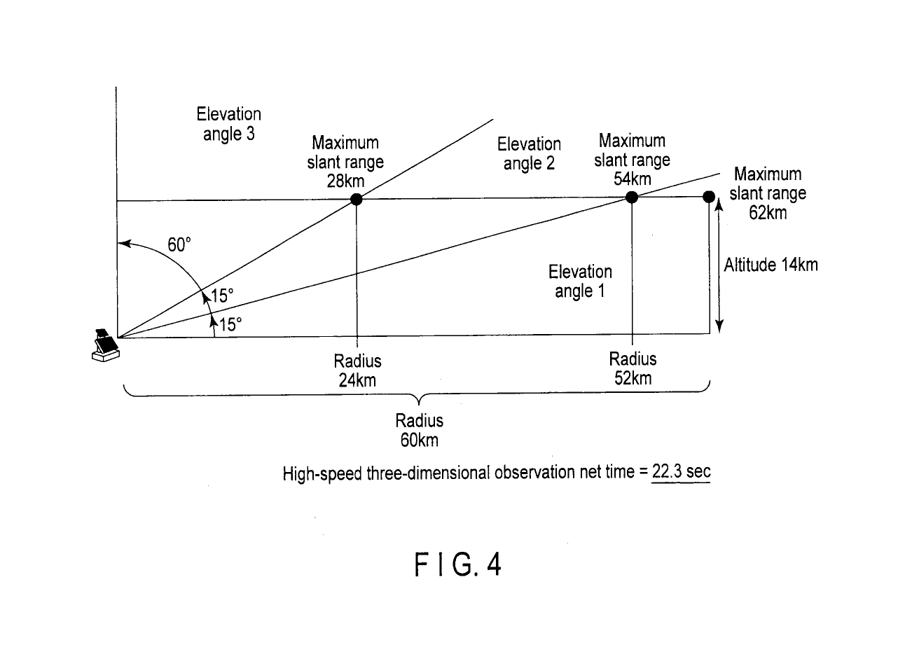

FIG. 4 is a view for explaining the time necessary for observation by the weather radar according to the embodiment. FIG. 4 shows a longitudinal section of the observation space shown in FIG. 3. Effects obtained by the weather radar according to the embodiment will be described with reference to FIG. 4 from the viewpoint of the time necessary for observation.

Referring to FIG. 4, the range of elevation angles of 0° to 15° is defined as elevation 1 area, the range of elevation angles of 15° to 30° is defined as elevation 2 area, and the range of elevation angles of 30° to 90° is defined as elevation 3 area. Assume that the first antenna unit 11-1 forms transmission beams in the elevation 1 area and the elevation 2 area, and the second antenna unit 11-2 forms transmission beams in the elevation 3 area.

Using the maximum slant range (direct distance from the antenna unit to the observation target) of each elevation angle as the central value, the elevation processing unit corresponding to the transmission beam width can be calculated for each transmission beam by

elevation processing unit=reception beam width/(maximum slant range×π/180°/200 m) (1)

When the elevation processing unit is determined, the number of simultaneously formed beams of each elevation area is calculated by

number of simultaneously formed beams=elevation range/elevation processing unit (2)

A pulse repetition frequency is calculated by

pulse repetition frequency=light velocity/(2×maximum slant range) (3)

The maximum slant range of elevation 1 area is 62 km, the maximum slant range of elevation 2 area is 54 km, and the maximum slant range of elevation 3 area is 28 km. In all areas, assume reception beam width=1°. The velocity of light is assumed to be 300,000 km/s. When these are substituted into equation (1), the elevation processing unit of elevation 1 area is about 0.18°, and the elevation processing unit of elevation 2 area is about 0.21°. These values are unified to 0.2° for the sake of simplicity. The elevation processing unit of elevation 3 area is about 0.41°. This value is rounded to 0.4° for the sake of simplicity.

The numbers of simultaneously formed beams are 75 in elevation 1 area and elevation 2 area and 150 in elevation 3 area. The pulse repetition frequencies are 2.4 kHz in elevation 1 area, 2.8 kHz in elevation 2 area, and 5.4 kHz in elevation 3 area.

The time (three-dimensional observation time) necessary for three-dimensional observation of each area is calculated by

three-dimensional observation time=(360°/azimuth processing unit)×required number of hits×Σ(1/pulse repetition frequency) (4)

When the azimuth processing unit in equation (4) is 0.2°, and the required number of hits is 16,

three-dimensional observation time=(360°/0.2)×16×Σ(1/5.4 kHz)≈5.3 sec (5)

holds in elevation 3 area (high elevation area).

three-dimensional observation time=(360°/0.2)×16×Σ(1/2.4 kHz+1/2.8 kHz)≈22.3 sec (6)

holds in an area (low elevation area) including elevation 1 area and elevation 2 area.

The net observation time (high-speed three-dimensional observation net time) is the larger one of the values calculated by equations (5) and (6). This is because according to the arrangement of the embodiment, observation in the high elevation area and that in the low elevation area can simultaneously be executed. Hence, according to the embodiment, the net time necessary for observing the observation space (time necessary for completely scanning the observation space) is 22.3 sec. Note that in the embodiment, the width of the transmission beam in the front direction of the antenna is defined as the beam width, and an increase in the beam width caused by the influence of beam scanning is neglected.

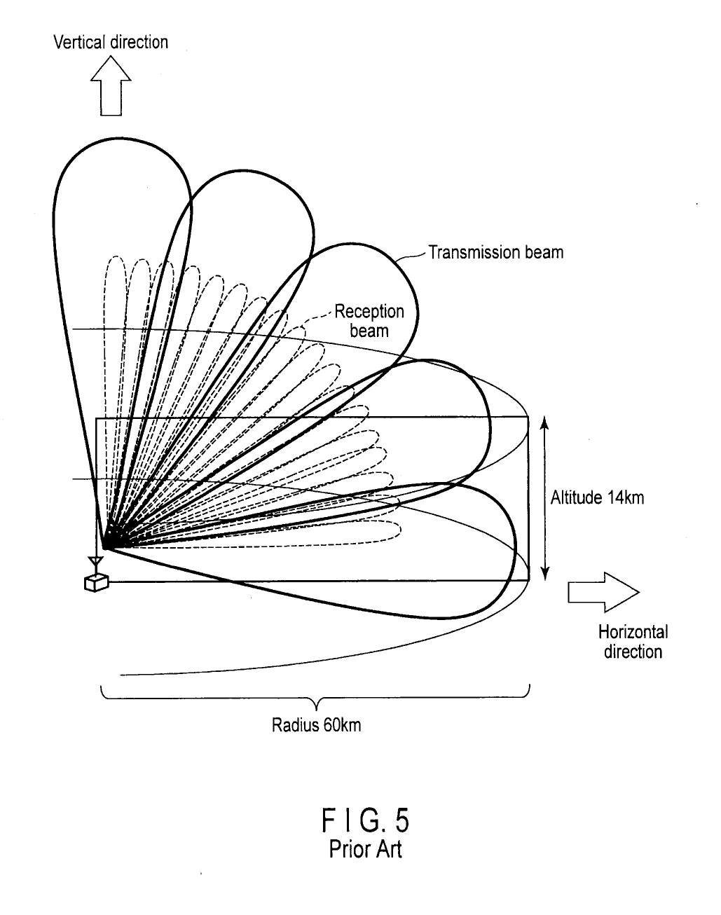

FIG. 5 is a view showing an example of weather observation by an existing weather radar for the sake of comparison. As shown in FIG. 5, the existing weather radar scans the observation space by transmission beams having a predetermined width using one antenna unit.

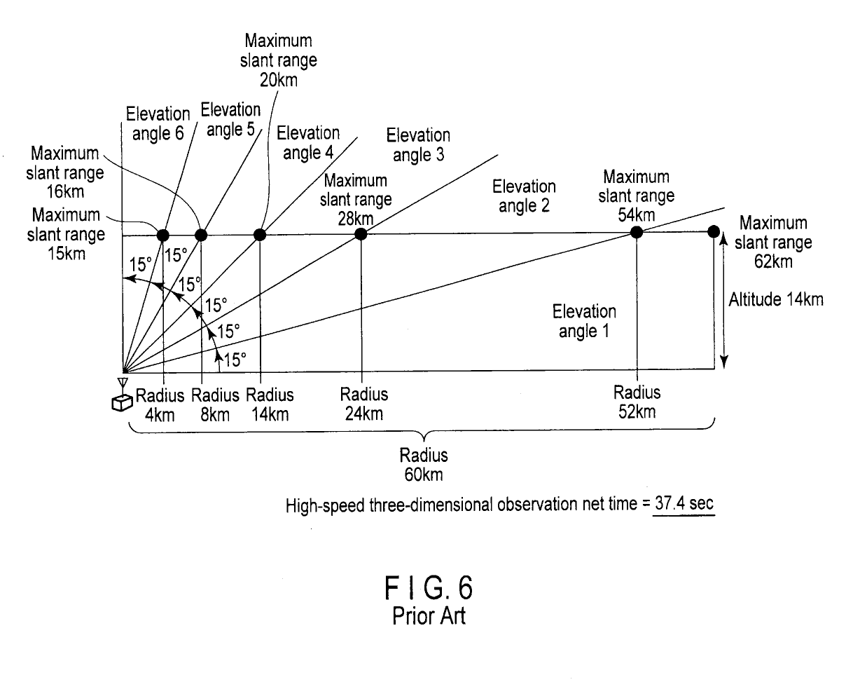

FIG. 6 is a view for explaining the time necessary for observation by the existing weather radar. Referring to FIG. 6, elevation 1 area and elevation 2 area as in FIG. 4 are assumed. In addition, the range of elevation angles of 30° to 45° is defined as elevation 3 area, the range of elevation angles of 45° to 60° is defined as elevation 4 area, the range of elevation angles of 60° to 75° is defined as elevation 5 area, and the range of elevation angles of 75° to 90° is defined as elevation 6 area.

The maximum slant range of elevation 1 area is 62 km, the maximum slant range of elevation 2 area is 54 km, the maximum slant range of elevation 3 area is 28 km, the maximum slant range of elevation 4 area is 20 km, the maximum slant range of elevation 5 area is 16 km, and the maximum slant range of elevation 6 area is 15 km. In all areas, assume reception beam width=1°. The velocity of light is assumed to be 300,000 km/s.

When these are substituted into equation (1), the elevation processing unit of elevation 1 area is about 0.18°, and the elevation processing unit of elevation 2 area is about 0.21°. These values are unified to 0.2° for the sake of simplicity. The elevation processing unit of elevation 3 area is about 0.41°. This value is rounded to 0.4° for the sake of simplicity.

In addition, the elevation processing unit of elevation 4 area is about 0.57°, the elevation processing unit of elevation 5 area is about 0.72°, and the elevation processing unit of elevation 6 area is about 0.76°. These values are rounded to 0.6°, 0.7°, and 0.8°, respectively, for the sake of simplicity.

When the elevation range in equation (2) is set to 15°, the numbers of simultaneously formed beams in elevation 1 area to elevation 6 area are approximately calculated as 75 beams, 75 beams, 38 beams, 25 beams, 22 beams, and 19 beams, respectively.

The pulse repetition frequencies are approximately 2.4 kHz in elevation 1 area, 2.8 kHz in elevation 2 area, 5.4 kHz in elevation 3 area, 7.5 kHz in elevation 4 area, 9.4 kHz in elevation 5 area, and 10 kHz in elevation 6 area. When these values are substituted into equation (4), the three-dimensional observation time is calculated by

three-dimensional observation time=(360°/0.2)×16×Σ(1/2.4 kHz+1/2.8 kHz+1/5.4 kHz+1/7.5 kHz+1/9.4 kHz+ 1/10 kHz)≈37.4 sec (7)

Note that the azimuth processing unit is 0.2°, and the required number of hits is 16, as in the assumption of FIG. 4.

As is apparent from above, the existing weather radar takes 37.4 sec to completely scan the observation space, although the weather radar of the embodiment takes 22.3 sec. That is, the weather radar of the embodiment can shorten the observation time to almost ½ as compared to the existing weather radar. While the observation time can be halved, the number of pulse hits can be doubled at the same time. Further, doubling the number of pulse hits doubles the spatial resolution. As a result, according to the embodiment, observation errors can be reduced by about 30%.

As described above, the weather radar according to the embodiment includes the first antenna unit 11-1 that covers the low elevation area, and the second antenna unit 11-2 that covers the high elevation area. Since weather observation is simultaneously performed in the elevation areas, the net observation time can be shortened. In addition, since the performance of the second antenna unit 11-2 can be suppressed as compared to that of the first antenna unit 11-1, it is possible to promote reductions in cost and size.

To transmit radio waves, the first antenna unit 11-1 and the second antenna unit 11-2 are used. However, to receive reflected waves, only the first antenna unit 11-1 is used. For this reason, the reception performance does not degrade. Furthermore, since the number of pulse hits per unit time can be increased by shortening the observation time, the spatial resolution can also be improved. For these reasons, according to the embodiment, it is possible to inexpensively provide a weather radar and a weather observation method with improved observation performance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A weather radar comprising:
a first antenna unit configured to electronically scan a first area of an observation space with first transmission beams;
a second antenna unit configured to electronically scan a second area whose slant range is shorter than that of the first area with second transmission beams of wider width than the first transmission beams;
a transmitter configured to transmit a radio wave to the first area from the first antenna unit with the first transmission beams and to transmit a radio wave to the second area from the second antenna unit with the second transmission beams; and
a receiver configured to form reception beams with the first antenna unit to receive a reflected wave from the first area and a reflected wave from the second area with the reception beams.

2. The weather radar of claim 1 wherein each of the first antenna unit and the second antenna unit comprises antenna elements arranged to form an array.

3. A weather observation method comprising:
electronically scanning a first area of an observation space with transmission beams of a first antenna unit;
electronically scanning a second area whose slant range is shorter than that of the first area with transmission beams of wider width than the transmission beam of a second antenna unit;
transmitting a radio wave to the first area from the first antenna unit with the first transmission beam;
transmitting a radio wave to the second area from the second antenna unit with the second transmission beam;
forming reception beams with the first antenna unit; and
receiving a reflected wave from the first area and a reflected wave from the second area with the reception beams.
